(19) United States
(12) Patent Application Publication
(10) Pub. No.: US 2017/0053274 A1
(43) Pub. Date: Feb. 23, 2017

(54) Auto-Adjudicating Real-Time Card Transactions Using Delayed Transaction Records

(71) Applicant: ConnectYourCare, LLC, Hunt Valley, MD (US)

(72) Inventor: Brian STROM, Baltimore, MD (US)

(21) Appl. No.: 15/239,691

(22) Filed: Aug. 17, 2016

Related U.S. Application Data
(60) Provisional application No. 62/206,656, filed on Aug. 18, 2015.

(51) Int. Cl. G06Q 20/40; G06Q 10/10; G06Q 20/34

(52) U.S. Cl. CPC G06Q 20/40; G06Q 20/34; G06Q 10/1057

(57) ABSTRACT

Disclosed herein are system, method, and computer program product embodiments for auto-adjudicating a real-time card transaction (TXN) received by a TXN manager of a plan management system. Upon receiving a delayed TXN record from a merchant, a card processor, or an insurance plan provider, an adjudication component of the plan management system may determine whether to associate the delayed TXN record with a card TXN record associated with the real-time card TXN. Based on the determining, the adjudication component may store the received delayed TXN record in association with the card TXN record. Then, the adjudication component determines whether the card TXN record can be adjudicated using the delayed TXN record associated with the card TXN record. In response to adjudicating the card TXN record, the adjudication component designates the card TXN as adjudicated.

### CROSS REFERENCE TO RELATED APPLICATIONS

This application claims the benefit of U.S. provisional patent application No. 62/206,656, entitled “AUTO-ADJUDICATING REAL-TIME CARD TRANSACTIONS USING DELAYED TRANSACTION RECORDS,” which was filed on Aug. 18, 2015, and which is hereby incorporated by reference in its entirety.

### BACKGROUND

A contribution funded account (CFA) is a tax-advantaged financial account that is set up through, for example, a benefit plan provided by an employer. A benefit plan is a type of employee benefit plan that may allow for contributions from an employee's pre-tax earnings or from the employee's employer to fund his or her CFA. An employee may be enrolled into a benefit plan or cafeteria plan provided by his or her employer and that is administered by a plan manager. The employee may use a payment card associated with his or her CFA to access funds within the CFA to pay for eligible expenses as established in the benefit plan. Any claim or requested fund disbursement from the CFA must be adjudicated by the plan manager. Adjudication refers to the process of verifying that a claim made against the CFA meets the eligibility requirements established in the benefit plan for that CFA.

When the employee swipes the payment card to pay for an expense, a real-time card transaction that is generated may be used to authenticate the payment. The real-time card transaction may also be automatically adjudicated by a plan management system of the plan manager. The processing of real-time card transactions, however, must comply with strict timing and formatting requirements as specified in industrywide transaction protocols and regulations. These requirements limit the types and amount of information contained within the real-time card transaction. Therefore, traditional plan management systems may only automatically adjudicate the real-time card transaction if the real-time card transaction is associated with the following three categories of transactions: co-payment transactions, Inventory Information Approval System (IIAS) based transactions, and recurring expenses adjudicated in a previous real-time card transaction.

Any other type of transaction may be adjudicated manually, if at all, or require the plan manager to solicit documentation records from the employee. Manual processing or requesting employee involvement is often error prone and time consuming.

### BRIEF DESCRIPTION OF THE DRAWINGS

The accompanying drawings are incorporated herein and form a part of the specification.

FIG. 1 is an example block diagram illustrating the multiple systems of respective entities involved in auto-adjudicating card transactions associated with an account within a benefit plan, according to an example embodiment.

FIG. 2 is an example block diagram illustrating the components within a plan management system to auto-adjudicate real-time card transactions, according to an example embodiment.

FIG. 3 is a flowchart illustrating steps for auto-adjudicating a real-time card transaction using delayed transaction records, according to an example embodiment.

FIG. 4 is a flowchart illustrating steps for associating a delayed transaction record with a real-time card transaction during auto-adjudication, according to an example embodiment.

FIG. 5 is a flowchart illustrating steps for auto-adjudicating a real-time card transaction using delayed transaction records associated with the real-time card transaction, according to an example embodiment.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for automatically adjudicating (auto-adjudicating) real-time card transactions (TXNs) made against an employee's contribution funded account (CFA) based on delayed TXN records. Embodiments enable a plan management system to receive and store delayed TXN records that may correspond to the real-time card TXNs. Upon determining whether one or more delayed TXN records is associated with a real-time card TXN, the plan management system may auto-adjudicate the real-time card TXN using one or more of the delayed TXN records that are associated with the real-time card TXN. In an embodiment, to perform auto-adjudication, the plan management system may parse the real-time card TXN and associated delayed TXN records to identity keywords and whether those keywords correspond to adjudication keywords. In an embodiment, the plan management system may auto-adjudicate individual sub-charges making up a total charge amount specified in the real-card TXN.

The CFA may be any tax-advantaged financial account that is set up by an employee through, for example, a benefit plan or cafeteria plan of the employer. The benefit plan selected by the employee may allow an employee to contribute a portion of his pre-tax earnings at the end of each pay period to fund the CFA. Depending on the CFA type as specified by the employer-provided benefit plan, the CFA may be employer funded, employee funded, or both employer and employee funded. The CFA may be tied to a payment card, e.g. a debit card, that enables the employee to access funds within the CFA to pay for qualified expenses as established by eligible service restrictions in the benefit plan for that CFA. The CFA may include, for example, a health savings account (HSA), a health reimbursement account (HRA), a flexible spending account (FSA) (such as a health FSA, a dependent care FSA, a limited-purpose FSA, or an adoption related FSA), or another type of account such as a wellness account.

In an embodiment, the CFA may also be classified as a general-purpose account or a limited-purpose account depending on the number of types of eligible services covered. A general-purpose account, such as a general-purpose health FSA, may include a large variety of eligible services such as dental, vision, pharmacy, medical, and other services. A limited-purpose account, such as a limited-purpose health FSA, may be limited in the number of eligible services as compared to a general-purpose account. For example, a limited-purpose health FSA may only include dental and vision as eligible service types.

Additionally, the CFA, such as an HSA, may provide accelerated access to funds within the CFA through a corresponding contribution funded on-demand account. For example, the HSA may itself be comprised of two sub-accounts: the traditional HSA (HSAT) that is employer or employee funded, and an HSA OnDemand (HSAOD), The contribution funded on-demand account, HSAOD, may be initialized with a sum of contributions to be made in a plan year, while the HSAT may contain a zeroed balance. In an embodiment, the HSAT may contain a preexisting balance from the previous plan year. As contribution amounts from each pay period are added to the HSAT, the same contribution amounts are deducted from the HSAOD to maintain total available funds within the combined HSA including the HSAT and the HSAOD. Therefore, a contribution from a pay period effectively transfers the specified contribution amount from the HSAOD to the HSAT. By enabling an employee accelerated access to future contributions stored within the HSAOD, the employee may more likely be able to pay for larger qualified expenses starting from the first day of the plan year. Greater detail for providing an on-demand based account is provided in reference to U.S. Provisional Application No. 62/131,057.

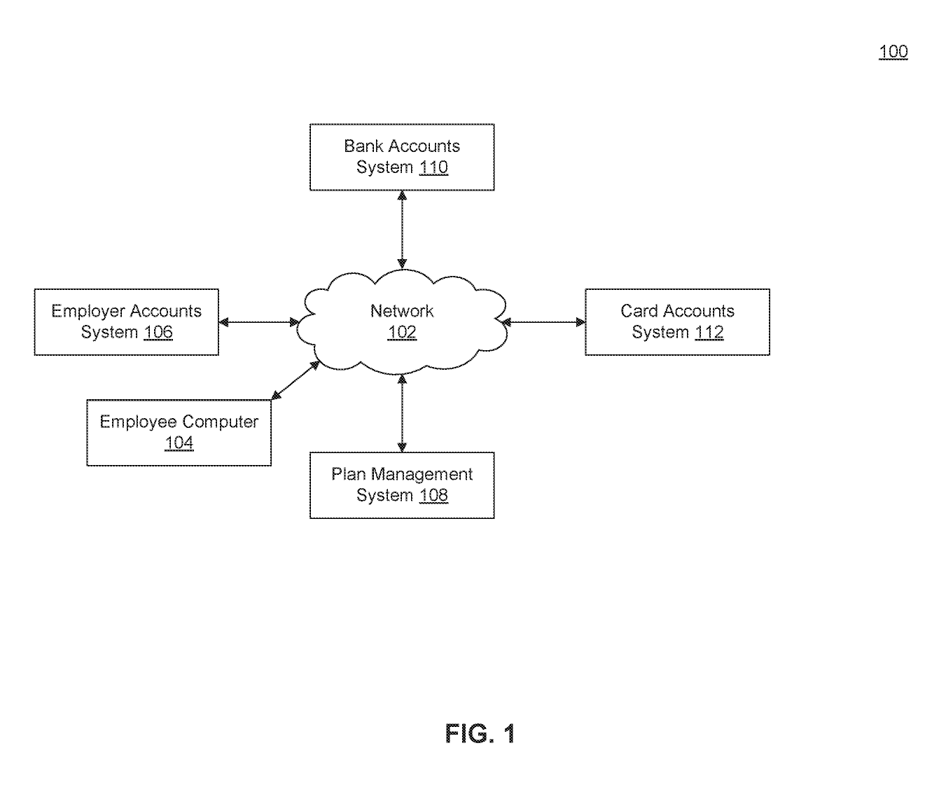

FIG. 1 illustrates auto-adjudication system 100 for auto-adjudicating an employee's real-time card TXNs made with a payment card that is associated with the employee's CFA account within a benefit plan, according to an embodiment. Auto-adjudication system 100 includes network 102, employee computer 104 operated by the employee, employer accounts system 106 of the employer, plan management system 108 of the plan manager, bank accounts system 110 of the bank, and card accounts system 112 of the card processing vendor. Each of the systems or computers may be implemented using one or more processors. Although the systems are depicted as remote systems connected via network 102 in auto-adjudication system 100, one or more systems may be operated by or maintained by one entity. For example, bank accounts system 110 and card accounts system 112 may be part of a single system operated by one entity.

Network 102 may enable plan management system 108 to communicate with the following systems to auto-adjudicate the employee's real-time card TXNs and administer the employee's CFA according to the employee's selected benefit plan: employer accounts system 106, bank accounts system 110, and card accounts system 112. In an embodiment, employee computer 104 may communicate with and view benefit plan information stored on any of the depicted systems. In an embodiment, employee computer 104 may access a portal, provided by plan management system 108, that acts as an interface for viewing card TXN information and whether they have been adjudicated. Network 102 may be an enterprise wide area network (WAN) utilizing Ethernet communications, although other wired and/or wireless communication techniques, protocols, and technologies may be used.

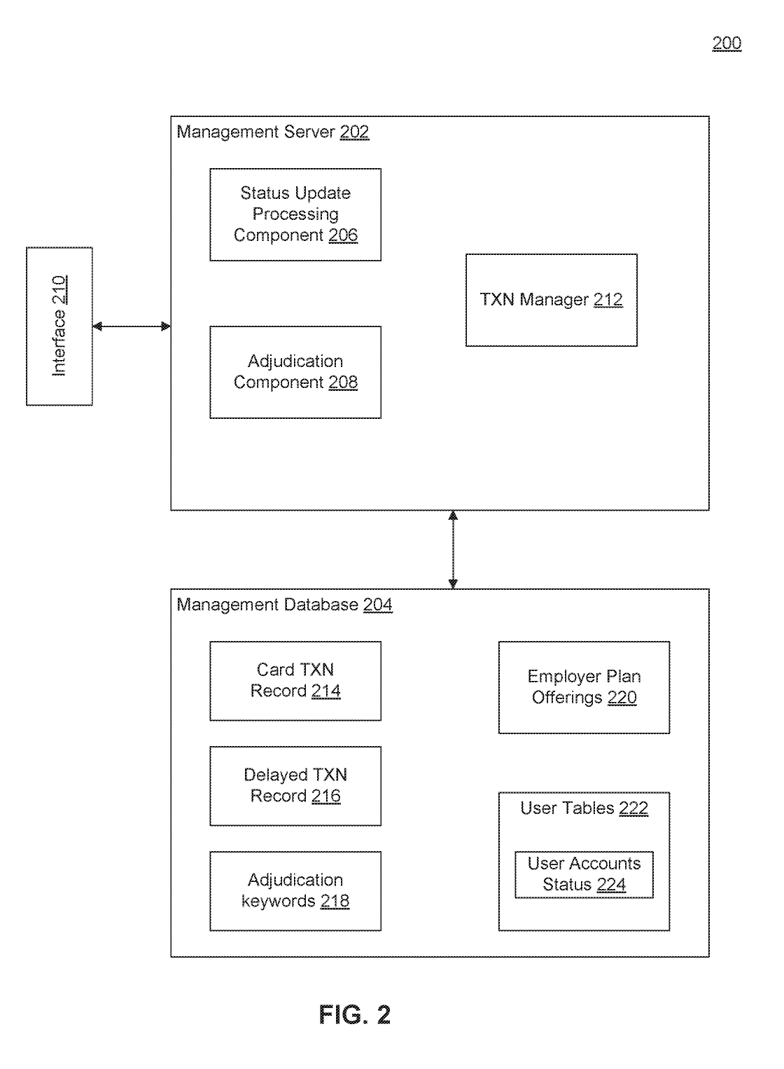

FIG. 2 illustrates plan management system 200 maintained by a plan manager to auto-adjudicate real-time card TXNs of an employee as part of administering the employee's CFA within his or her selected benefit plan, according to an exemplary embodiment of plan management system 108. Plan management system 200 may include interface 210, management server 202, and management database 204. Though depicted as a single server, management server 202 may be representative of a plurality of servers, each of which may be implemented by one or more processors. Likewise, management database 204 may be representative of a plurality of databases coupled to a plurality of management servers. Management database 204 may be implemented on one or more storage devices.

Interface 210 may be configured to enable plan management system 200, specifically management server 202, to communicate with one or more of the systems depicted in FIG. 1. Though depicted as a separate component, interface 210 may be implemented within management server 202, according to an exemplary embodiment.

Management database 204 may be configured to store employer information within employer plan offerings 220 and employee information within user tables 222. Employer plan offerings 220 may include database tables for storing benefit plan offerings received from and provided by employer accounts system 106. A benefit plan offering may include associated accounts and respective eligible services. An employee's benefit plan selection, received from employer accounts system 106 or employee computer 104, may be stored in user tables 222. User accounts status 224 within user tables 222 may be configured to store account information, such as account balances and operating status, of CFAs within an employee's selected benefit plan.

Management database 204 may be further configured to store card TXN record 214, delayed TXN record 216, and adjudication keywords 218 to enable management server 202 to auto-adjudicate an employee's real-time card TXNs. Card TXN record 214 may include one or more tables for storing the real-time card TXNs. And, delayed TXN record 216 may include one or more tables for storing subsequent documentation, such as receipts or TXN information, that do not follow the form of the real-time card TXNs, further explained below.

Adjudication keywords 218 may be representative of adjudication databases including one or more dictionaries (or associative arrays) for storing associations between words and eligible service type. In an embodiment, data structures including hash tables, red-black trees, and lists may be used to store and represent the associations. For example, an eligible service type, “P” or Pharmacy, may be associated with a set of eligible drugs.

In an embodiment, a dictionary of words may be configured for each Merchant Code Category (MCC). An MCC is a number assigned to a business that classifies the business based on the type of goods or services the business provides. The MCC code may be information contained within a received real-time card TXN.

Management server 202 may be configured to include status update processing component 206, adjudication component 208, and TXN manager 212. One or more of the depicted components may be implemented as processing systems comprising one or more sub-components. For example, adjudication component 208 and TXN manager 212 may form an adjudication processing system implemented on management server 202. These sub-components may include an interface for communicating within and/or across systems and a distribution component for sending information to other components and/or across systems.

Status update processing component 206 may be configured to communicate with employer accounts system 106 in order to configure and provide an employer's benefit plan offering and an employee's CFAs within a selected benefit plan across the multiple systems of FIG. 1, including plan management system 108, bank accounts system 110, and card accounts system 112. For example, status update processing component 206 may receive updates to an employer's benefit plan offering and store received updates in employer plan offerings 220. In an embodiment, status update processing component 206 may receive, from bank accounts system 110, information indicating that funds within one or more CFAs of the benefit plan are being invested.

Additionally, status update processing component 206 may receive a request from employer accounts system 106 or employee computer 104 for updating an employee's benefit plan. Accordingly, status update processing component 206 may update records stored in management database 204, such as user tables 222, and configure the accounts of the benefit plan in user account status 224. Then, status update processing component 206 may initiate a reconciliation process and send update information to bank accounts system 110 and card accounts system 112. In an embodiment, updating the benefit plan may include enrolling a new or existing employee into a new benefit plan in accordance with an employee's selected employer benefit plan.

After enrollment, an employee may use a payment card associated with one or more CFAs of the employee's benefit plan to pay for eligible services. In card payment processing, when the employee swipes his card or enters his payment card information online to pay for a good or service provided by a merchant, card accounts system 112 may generate a corresponding real-time card TXN. Card accounts system 112 will verify information within the real-time card TXN before authorizing the employee's payment.

TXN manager 212 may be configured to receive the real-time card TXN from card accounts system 112, and store the received real-time card TXN as a card TXN record in card TXN record 214. In an embodiment, TXN manager 212 may receive the real-time card TXN from a computer appliance, such as a point-of-sale terminal provided by the merchant and administered by card accounts system 112. The point-of-sale terminal is a transaction acquiring device that captures an employee's card swipe and forwards a corresponding real-time card TXN to card accounts system 112 for authorization. In an embodiment, the TXN manager may receive the real-time card TXN from a software appliance, such as a payment gateway, which is an e-commerce application service provider service for authorizing payments via a software payment portal for online purchases.

Processing of the real-time card TXN must comply with industrywide transaction protocols and regulations. These requirements may include the types and amount of information contained within the real-time card TXN as well as a time limit for authorizing the real-time card TXN, further constraining the amount of allotted information. Therefore, the real-time card TXN received by TXN manager 212 may contain limited information including the following: transaction ID, account ID, date of service, location of payment, total charge amount, service provider, and Merchant Category Code (MCC).

A plan manager, such as one operating plan management system 200, may be able to only auto-adjudicate the real-time card TXN based on the limited information for certain types of transactions. For example, the plan manager may auto-adjudicate the real-time card TXN if the associated limited information indicates that the real-timecard TXN is an Inventory Information Approval System (IIAS) transaction. IIAS is a point-of-sale technology used by retailers that separate expenses that are medical related from expenses that are not medical related. But, not all retailers or service providers are able to implement IIAS. In these cases, the plan manager may be unable to auto-adjudicate the total charge amount. Additionally, an employee may have a limited-purpose type CFA, in which case not all medical related expenses may be eligible for coverage.

While a specific service provider may be associated with a medical related MCC, the total charge amount may include purchases that are not eligible for coverage by a CFA. For example, an employee may pay for services and products during an eye doctor appointment. The MCC associated with a total charge amount may be vision related, which may be a category covered by the CFA depending on the employee's benefit plan. The total transaction amount may include sub-charges for examination, eyeglasses, sunglasses, and warranties. But, only the total charged amount is included in the real-time card TXN. According to CFA terms and limitations, the examination and eyeglasses may be covered as eligible vision related services, but the sunglasses and warranties may not be covered. Under federal regulations, the plan manager is required to adjudicate CFA expenses. So, if the plan manager cannot auto-adjudicate the real-time card TXN, then the plan manager may need to request adjudication documentation from the employee under traditional processes.

In an embodiment, TXN manager 212 is configured to receive a delayed TXN record that may correspond to a record from card TXN record 214, and store the received delayed TXN record in delayed TXN record 216. In contrast to the real-time card TXN contained in the card TXN record, processing of the delayed TXN record may not be bound by strict industrywide formatting and timing processing requirements, because the delayed TXN record is not used to authorize an associated purchase of goods and services. Therefore, the delayed TXN record may contain finer granularity information including, for example, line item details about sub-charges making up a total charge in the real-time card TXN.

The delayed TXN record may be received from card account system 112 as a separate type of data than the real-time card TXN. In an embodiment, the delayed TXN record may originate from the merchant or an insurance plan provider instead of from card accounts system 112. The delayed TXN record may be received from a web service or as a structured file according to the record originator. For example, when the employee uses his payment card to pay for dental related goods and services at the dentist office, the merchant (i.e., dentist) may concurrently or subsequently forward an online line item receipt as a delayed TXN record to TXN manager 212.

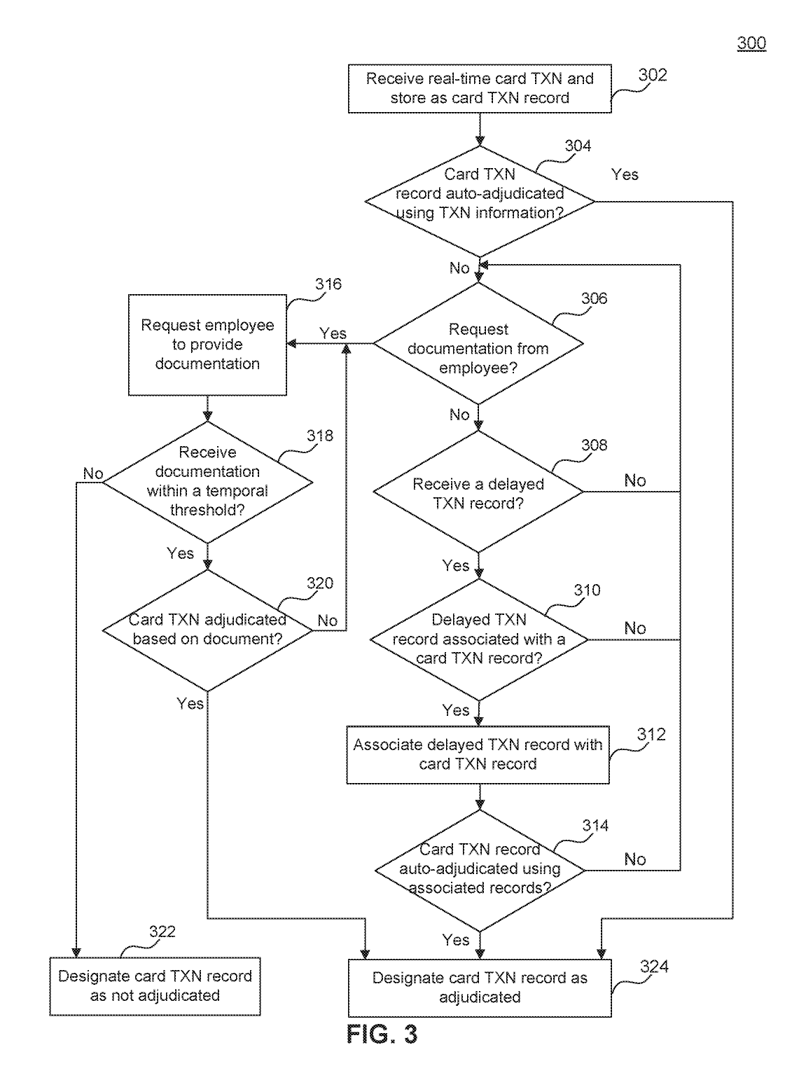

Upon receiving the real-time card TXN and one or more delayed TXN records, adjudication component 208 may be configured to perform auto-adjudication of the real-time card TXN according to process 300 described with respect to FIG. 3. In an embodiment, adjudication component 208 may be a sub-component within TXN manager 212 or be initiated by TXN manager 212 upon receiving a delayed TXN record.

FIG. 3 illustrates a process 300 for auto-adjudicating a real-time card TXN using delayed TXN records, according to an example embodiment. Steps of process 300 may be performed across multiple systems, including employer account system 106, employee computer 104, bank accounts system 110, plan management system 108, and card accounts system 112. Process 300 may be performed by processing logic that may include hardware (e.g., circuitry, dedicated logic, programmable logic, microcode, etc.), software (e.g., instructions run on a processing device), or any such combination. In an embodiment, steps of FIG. 3 may not need to be performed in the exact order shown, as one skilled in the arts would understand.

As discussed, an employee may select a benefit plan offered by employer accounts system 106 and administered by plan management system 108. When bank accounts system 110 enrolls the employee into a CFA of the benefit plan, bank accounts system 110 may issue the employee a payment card to pay for eligible services (and products) permitted by the benefit plan.

In step 302, a TXN manager from plan management system 108, such as TXN manager 212 from plan management system 200, receives a real-time card TXN from card accounts system 112, which the TXN manager subsequently stores as a card TXN record in a management database, such as in card TXN record 214 in management database 204. For example, the employee's payment card information may be captured via a computer or software appliance during an eye doctor appointment. The appliance then generates a corresponding real-time card TXN processed by card accounts system 112. In an embodiment, the adjudication component may designate the card TXN record as pending adjudication.

In step 304, an adjudication component within the plan management system, such as adjudication component 208 from management server 202, attempts to auto-adjudicate the card TXN record (and associated real-time card TXN) based on information within the card TXN record. For example, the adjudication component may automatically adjudicate the card TXN record if the information indicates that the real-time card TXN was for a co-payment, for IIAS expenses, or for a recurring expense that was previously adjudicated. Process 300 proceeds to step 324 if the card TXN record is successfully auto-adjudicated. Otherwise, process 300 proceeds to step 306.

In the eye doctor appointment example, the merchant (i.e., eye doctor) does not implement IIAS and not all the sub-charges of a total charge associated with the card TXN record may be for eligible services (or products). For example, an employee's glasses prescription sub-charge may be eligible, but a sunglasses sub-charge may not be eligible.

In step 306, when the card TXN record could not be successfully auto-adjudicated, the adjudication component determines whether to request documentation from the employee to adjudicate the card TXN record. In an embodiment, the adjudication component may make the determination based on whether a temporal threshold specified by plan management system 108 has been reached or exceeded. The temporal threshold may indicate a maximum amount of time, e.g. number of days, since the real-time card TXN was received in step 302. Process 300 proceeds to step 316 if the documentation from the employee is to be requested. Otherwise, process 300 proceeds to step 308.

In step 308, the TXN manager receives a delayed TXN record, which the TXN manager subsequently stores as a delayed TXN record in a management database, such as in delayed TXN record 216 in management database 204. In an embodiment, the delayed TXN record may be received from card accounts system 112, the merchant providing the service/product associated with the card TXN record, or an insurance plan provider. In an embodiment, the delayed TXN record may be sent as a separate TXN concurrently with or subsequent to the real-time card TXN. If no documentation is received, process 300 may proceed back to step 306.

In the eye doctor appointment example, the merchant may send a delayed TXN record, such as an online receipt, including line item details about each sub-charge of the total charge in the real-time card TXN to plan management system 108 directly or through a third party service, such as card accounts system 112.

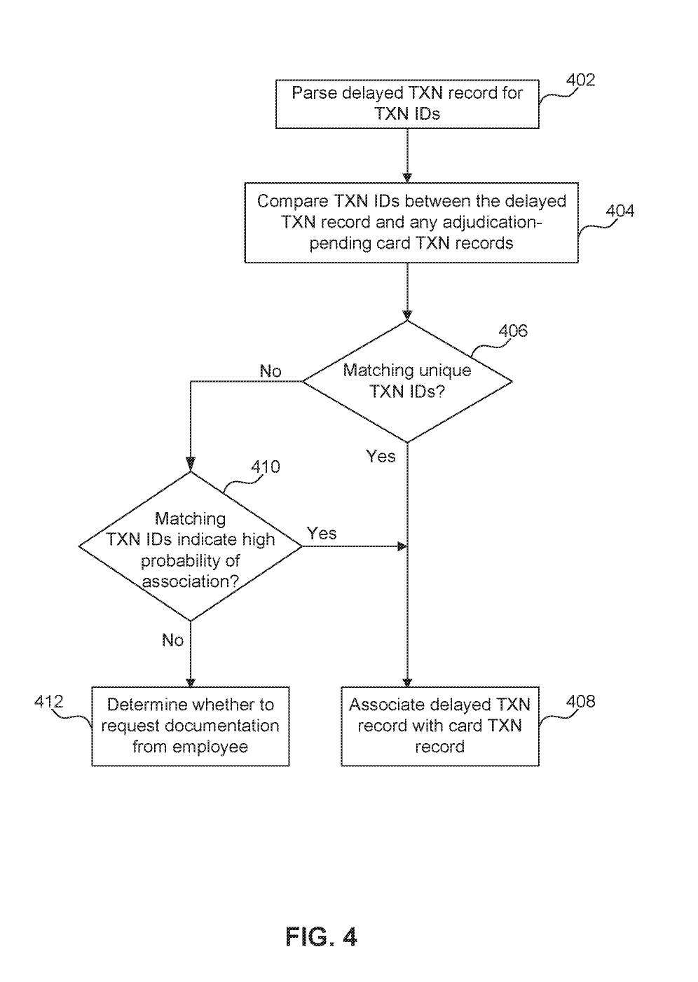

In step 310, when the delayed TXN record is received, the adjudication component determines whether the received delayed TXN record can be associated with or corresponds to a stored card TXN record. In an embodiment, the determination is made based on matching identification information between the delayed TXN record and the card TXN record, as further described with regards to FIG. 4. Process 300 proceeds back to step 306 if no association was found.

In step 312, the adjudication component links or associates the delayed TXN record with the determined stored card TXN record from step 310. In an embodiment, one or more delayed TXN records may be associated with the same stored card TXN record and the adjudication component may store these associations in management database 204, as described in FIG. 2.

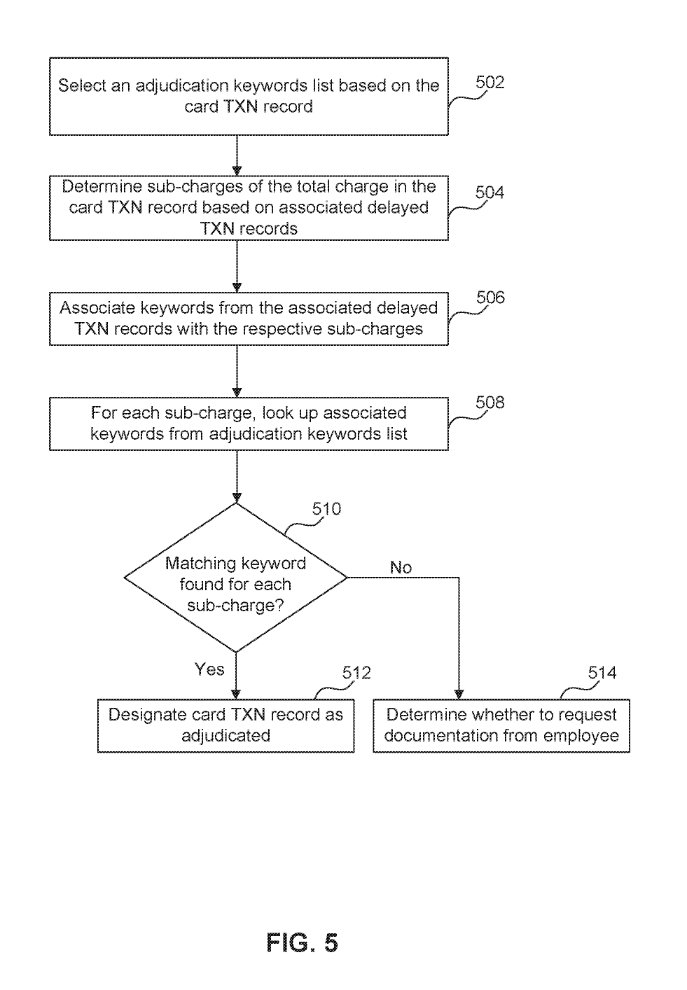

In step 314, the adjudication component determines whether to auto-adjudicate the real-time card TXN associated with the received delayed TXN record based on one or more delayed TXN records that have been linked or associated with the card TXN record. In an embodiment, the auto-adjudication determination is made based on matching keywords of associated delayed TXN records with an adjudication keywords list, such as adjudication keywords 218 in management database 204, as further described with regards to FIGS. 2 and 5. Process 300 proceeds to step 306 if the card TXN record remains un-adjudicated.

As discussed, delayed TXN records may not be constrained by formatting rules and timing requirements associated with real-time card TXN processing. Depending on the record originator, delayed TXN records may include receipts, line item summaries, or custom records. For example, at the end of a doctor's appointment, a receptionist in the doctor's office may generate a short summary describing the services performed and associated charges. While this short summary may be stored internally at the doctor's office, this short summary may also be an example delayed TXN record used by the adjudication component to perform auto-adjudication. Particularly, the adjudication component may match keywords within the short summary against an adjudication keywords list to determine whether one or more charges (or sub-charges) associated with a card TXN record may be adjudicated.

In an embodiment, a service or product provider may generate a receipt to give to an employee. The receipt, an example delayed TXN record, may include services or goods that were purchased during a payment associated with a real-time card TXN. In an embodiment, a point-of-sale terminal producing the receipt may concurrently or subsequently submit a copy of the receipt to the plan manager or the card vendor. Similar to analyzing the line item summaries, the adjudication component may search and examine the keywords of the receipt to perform auto-adjudication of the real-time card TXN.

Returning to step 306, if the adjudication component determines to request documentation from the employee to adjudicate the card TXN record, process 300 proceeds to step 316, where auto-adjudication without employee intervention is no longer possible.

In step 316, the adjudication component may request the employee to provide documentation for adjudicating the card TXN record stored in step 302. The request may be communicated via phone, mail, or e-mail.

In step 318, the adjudication component determines whether the requested documentation was received from the employee within a temporal threshold specified by plan management system 108, bank accounts system 110, or as prescribed by law. The temporal threshold may indicate a maximum amount of time, e.g. number of days, since the real-time card TXN was received in step 302. Process 300 proceeds to step 320 if documentation was received.

In step 322, if no documentation was received within the temporal threshold, the adjudication component designates the card TXN record as not adjudicated.

In step 320, whether the documentation adjudicates the card TXN record is determined. Often, the employee may send paper documents or submit electronic copies of scanned documents. The documentation likely varies in format from document to document and from employee to employee. Therefore, a person, such as an administrator, from the plan manager may be required to adjudicate the card TXN record. Human intervention often introduces errors, increases processing delays, and is costly. Process 300 describes auto-adjudication steps 308-314 that enhance the traditional auto-adjudication process, reduce the amount of real-time card TXNs that need to be auto-adjudicated, and reduce employee involvement.

In step 324, when the card TXN record is determined to be adjudicated, the adjudication component designates the card TXN record storing the real-time card TXN as adjudicated in management database 204.

FIG. 4 illustrates process 400 for associating a received delayed TXN record with a stored card TXN record during auto-adjudication, according to an example embodiment. In an embodiment, process 400 describes in greater detail step 310 from FIG. 3. Process 400 may be performed by processing logic that may include hardware (e.g., circuitry, dedicated logic, programmable logic, microcode, etc.), software (e.g., instructions run on a processing device), or any such combination. In an embodiment, steps of FIG. 4 may not need to be performed in the exact order shown, as one skilled in the arts would understand.

In step 402, upon receiving the delayed TXN record, an adjudication component, such as adjudication component 208 from management server 202, parses the received delayed TXN record for TXN identifiers (IDs). In an embodiment, TXN IDs may be keywords or fields of the delayed TXN record. These keywords or fields may include a unique TXN number, a date of service, a charge amount, an account ID, a merchant ID, or an MCC.

In step 404, the adjudication component compares the parsed TXN IDs with information from card TXN records that have not been adjudicated in an embodiment, the types of TXN IDs may be compared based on a priority associated with each type of TXN ID.

In step 406, the adjudication component may prioritize matching unique TXN IDs that the delayed TXN record and a stored card TXN record may have in common. For example, the adjudication may determine that the delayed TXN record and a card TXN record have a matching unique TXN ID. If any unique TXN IDs were successfully matched, process 400 proceeds to step 408.

In step 408, upon determining that the delayed TXN record corresponds to a card TXN record, the adjudication component associates the delayed TXN record with the card TXN record and stores this determined association in management database 204, as further described in step 312 from FIG. 3.

In step 410, the adjudication component determines whether one or more TXN IDs from the delayed TXN record matches the TXN IDs of a card TXN record and whether the number of matches indicates a high probability of association between the delayed TXN record and the card TXN record. For example, the higher the number of matches that are found, the higher the probability that the TXN records are related and should be associated with each other. In an embodiment, if any TXN ID from the delayed TXN record contradicts a corresponding TXN ID from the card TXN record, the adjudication component tries to match the delayed TXN record with another card TXN record that has not been adjudicated.

In step 412, when no match was determined, the adjudication component determines whether to request documentation from the employee, as further described in step 306 from FIG. 3.

FIG. 5 illustrates a process 500 for determining whether a card TXN record associated with a received delayed TXN record can be auto-adjudicated, according to an example embodiment. In an embodiment, process 500 describes in greater detail step 314 from FIG. 3. Process 500 may be performed by processing logic that may include hardware (e.g. circuitry, dedicated logic, programmable logic, microcode, etc.), software (e.g., instructions run on a processing device), or any such combination. In an embodiment, steps of FIG. 5 may not need to be performed in the exact order shown, as one skilled in the arts would understand.

In step 502, an adjudication component within a plan management system, such as adjudication component 208 from plan management system 200, selects an adjudication keywords list from a management database, such as adjudication keywords 218 from management database 204, based on the card TXN record determined to be associated with a received delayed TXN record. The determination is further explained in steps 310 from FIG. 3 or process 400 of FIG. 4. In an embodiment, other data structures such as hash tables or binary trees may be used and selected instead of lists, further detailed with regards to FIG. 2.

In an embodiment, the selected adjudication keywords list may be based on a type of the determined card TXN record, for example, as dictated by an MCC associated with the card TXN record. The selected adjudication keywords list may also be selected based on the requirements and eligibility restrictions associated with the CFA of the employee's benefit plan.

In step 504, the adjudication component determines sub-charges, if any, of the total charge in the card TXN record based on one or more delayed TXN records linked or associated with the card TXN record. For example, a card TXN record may indicate a total charge representative of an employee's payment for five therapy sessions at a physical therapist. A delayed TXN record may be, for example, a receipt containing a sub-charge associated with one of the five therapy sessions.

In step 506, the adjudication component associates keywords from the delayed TXN records associated with the card TXN record with the respective sub-charges.

In step 508, for each sub-charge, the adjudication component searches for the associated keywords from the selected adjudication keywords list to determine whether that sub-charge is adjudicated based on the delayed TXN records.

In step 510, the adjudication component determines whether matching keywords were found from the adjudication keywords list for each sub-charge. If the sub-charges could not be adjudicated, process 500 proceeds to step 514. Otherwise, the adjudication component successfully auto-adjudicates the real-time card TXN associated with the card TXN record and process 500 proceeds to step 512. In an embodiment, if any of the five sessions of the above therapy sessions example could not be adjudicated, process 500 may proceed to step 514.

In step 512, upon determining that the card TXN record was adjudicated, the adjudication component designates the card TXN record as adjudicated within the management database, as further described in step 324 from FIG. 3.

In step 514, upon determining that the card TXN record could not be adjudicated, the adjudication component determines whether to request documentation from the employee who originated the real-time card TXN associated with the card TXN record, as further described in step 306 from FIG. 3.

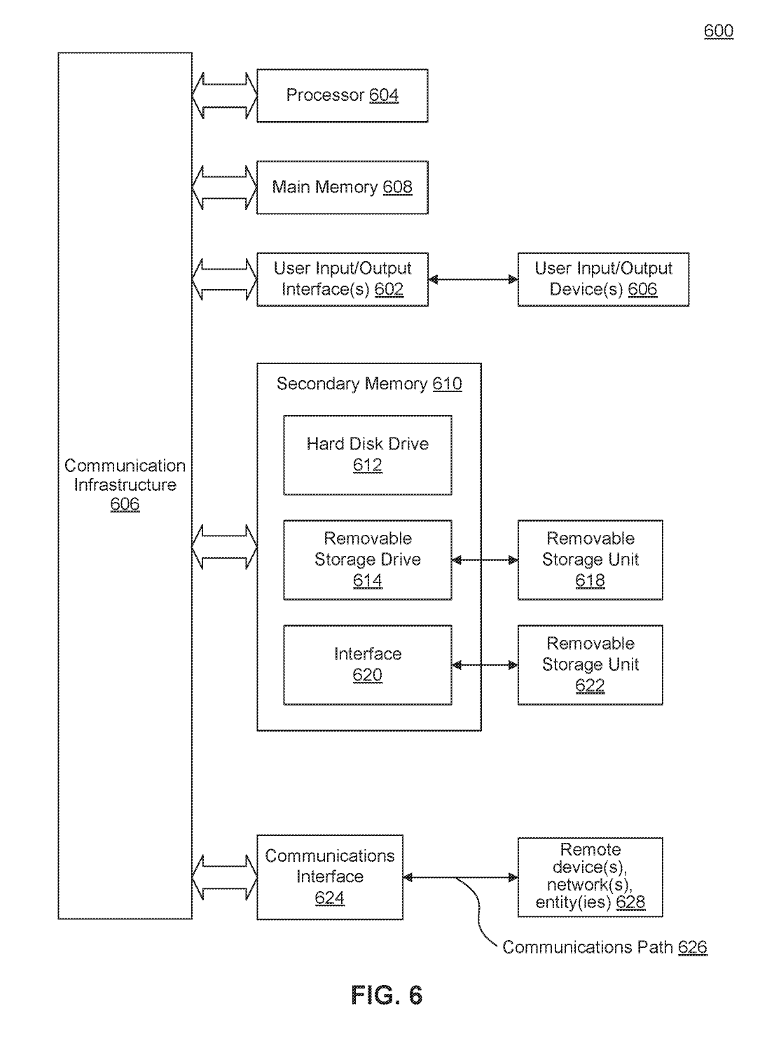

FIG. 6 is an example computer system that may be used to implement components of the systems illustrated in FIGS. 1-2, or which may be specially programmed to implement steps of the processes illustrated in FIGS. 3-5.

Various embodiments can be implemented, for example, using one or more well-known computer systems, such as computer system 600 shown in FIG. 6. Computer system 600 can be any well-known computer capable of performing the functions described herein.

Computer system 600 includes one or more processors (also called central processing units, or CPUs), such as a processor 604. Processor 604 is connected to a communication infrastructure or bus 606.

One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 6. In particular, embodiments may operate with software, hardware, and/or operating system implementations other than those described herein.

It is to be appreciated that the Detailed Description section, and not the Summary and

Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A method for auto-adjudicating, comprising:
receiving, by a transaction (TXN) manager of a plan management system, a real-time card TXN from a card processor, the received real-time card TXN identifying funds being withdrawn from a contribution funded account (CFA) of a user and including a TXN identification (ID), a TXN date, a TXN amount, a TXN location, and a TXN Merchant Category Code (MCC);
determining, by an adjudication component of the plan management system, that the real-time card TXN cannot be adjudicated based on information contained within the real-time card TXN;
receiving, by the TXN manager, a delayed TXN record from one or more of a merchant, a card processor, or an insurance plan provider, wherein the delayed TXN record is received subsequent to the real-time card TXN and does not follow the protocol and regulations associated with processing the real-time card TXN;
determining, by the adjudication component, whether to associate the delayed TXN record with a card TXN record associated with the real-time card TXN based on matching information from the delayed TXN record that identifies the user associated with the card TXN record;
in response to determining that the delayed TXN record is associated with the card TXN record, storing, by the adjudication component, the delayed TXN record in association with the card TXN record;
determining, by the adjudication component, whether the card TXN record can be adjudicated using the stored delayed TXN record; and
designating, by the adjudication component, the card TXN record as adjudicated in response to adjudicating the card TXN record.

2. The method of claim 1, the determining whether to associate the delayed TXN record with the card TXN record further comprising:
matching a number of fields from the card TXN record with corresponding fields from the delayed TXN record, wherein a mismatch indicates that the delayed TXN record is not associated with the real-time card TXN.

3. The method of claim 1, wherein the information from the delayed TXN record includes one or more of the following: the TXN identification (ID), the TXN date, the TXN amount, the TXN location, or the TXN Merchant Category Code (MCC).

4. The method of claim 1, wherein the real-time card TXN is received from a point-of-sale terminal or from the card processor.

5. The method of claim 1, the determining whether the card TXN record can be adjudicated comprising:
determining whether keywords within the delayed TXN record correspond to adjudication keywords within an adjudication keywords database.

6. The method of claim 1, wherein an adjudication keywords database includes a plurality of MCCs, each MCC being associated with a set of adjudication keywords, the determining whether the card TXN record can be adjudicated comprising:
matching keywords within the delayed TXN record against a set of adjudication keywords associated with an MCC corresponding to the transaction MCC.

7. The method of claim 1, wherein the delayed TXN record is a first delayed TXN record, the method further comprising:
receiving a second delayed TXN record from one or more of a merchant, a card processor, or an insurance plan provider;
determining whether to associate the second delayed TXN record with the card TXN record based on matching information from the second delayed TXN with information from the card TXN record or the first delayed TXN record;
in response to determining that the second delayed TXN record is associated with the card TXN record, storing the second delayed TXN record in association with the card TXN record; and
determining whether the card TXN record can be adjudicated using the first and second delayed TXN records.

8. The method of claim 1, further comprising:
receiving the delayed TXN record from a web service or a structured file.

9. A system for auto-adjudicating, comprising:
a management database configured to store card transaction (TXN) records and delayed TXN records; and
an adjudication processing system, implemented by a management server coupled to the management database, the adjudication processing system comprising:
a transaction (TXN) manager configured to:
receive a real-time card TXN from a card processor, the received real-time card TXN identifying funds being withdrawn from a contribution funded account (CFA) of a user and including a transaction identification (ID), a transaction date, a transaction amount, a transaction location, and a transaction Merchant Category Code (MCC); and
receive a delayed TXN record from one or more of a merchant, a card processor, or an insurance plan provider, wherein the delayed TXN record is received subsequent to the real-time card TXN and does not follow the protocol and regulations associated with processing the real-time card TXN;
an adjudication component configured to:
determine that the real-time card TXN cannot be adjudicated based on information contained within the real-time card TXN;
determine whether to associate the delayed TXN record with a card TXN record stored in the management database and associated with the real-time card TXN based on matching information from the delayed TXN record that identifies the user associated with the card TXN record;
in response to determining that the delayed TXN record is associated with the card TXN record, store the delayed TXN record in association with the card TXN record;
determine whether the card TXN record can be adjudicated using the stored delayed TXN record; and
designate the card TXN record as adjudicated in response to adjudicating the card TXN record.

10. The system of claim 9, wherein to determine whether to associate the delayed TXN record with the card TXN record, the adjudication component is configured to:
match a number of fields from the card TXN record with corresponding fields from the delayed TXN record, wherein a mismatch indicates that the delayed TXN record is not associated with the real-time card TXN.

11. The system of claim 9, wherein the information from the delayed TXN record includes one or more of the following: the TXN identification (ID), the TXN date, the TXN amount, the TXN location, or the TXN Merchant Category Code (MCC).

12. The system of claim 9, wherein the real-time card TXN is received from a point-of-sale terminal or from the card processor.

13. The system of claim 9, wherein the adjudication component is further configured to determine whether the card TXN record can be adjudicated using the delayed TXN record by:
determining whether keywords within the delayed TXN record correspond to adjudication keywords within an adjudication keywords database of the management database.

14. The system of claim 9, wherein the management database comprises an adjudication keywords database that includes a plurality of MCCs, each MCC being associated with a set of adjudication keywords, and wherein the adjudication component is further configured to determine whether the card TXN record can be adjudicated using the delayed TXN record by:
matching keywords within the delayed TXN record against a set of adjudication keywords associated with an MCC corresponding to the transaction MCC.

15. The system of claim 9, wherein the delayed TXN record is a first delayed TXN record, wherein the TXN manager is further configured to receive a second delayed TXN record from one or more of a merchant, a card processor, or an insurance plan provider, and wherein the adjudication component is further configured to:
determine whether to associate the second delayed TXN record with the card TXN record based on matching information from the second delayed TXN with information from the card TXN record or the first delayed TXN record;
in response to determining that the second delayed TXN record is associated with the card TXN record, store the second delayed TXN record in association with the card TXN record; and
determine whether the card TXN record can be adjudicated using the first and second delayed TXN records.

16. The system of claim 9, wherein the TXN manager is further configured to:
receive the delayed TXN record from a web service or a structured file.

17. A non-transitory computer-readable device having instructions stored thereon that, when executed by at least one computing device, causes the at least one computing device to perform operations comprising:
receiving, by a transaction (TXN) manager of a plan management system, a real-time card TXN from a card processor, the received real-time card TXN identifying funds being withdrawn from a contribution funded account (CFA) of a user and including a TXN identification (ID), a TXN date, a TXN amount, a TXN location, and a TXN Merchant Category Code (MCC);
determining, by an adjudication component of the plan management system, that the real-time card TXN cannot be adjudicated based on information contained within the real-time card TXN;
receiving, by the TXN manager, a delayed TXN record from one or more of a merchant, a card processor, or an insurance plan provider, wherein the delayed TXN record is received subsequent to the real-time card TXN and does not follow the protocol and regulations associated with processing the real-time card TXN;
determining, by the adjudication component, whether to associate the delayed TXN record with a card TXN record associated with the real-time card TXN based on matching information from the delayed TXN record that identifies the user associated with the card TXN record;
in response to determining that the delayed TXN record is associated with the card TXN record, storing, by the adjudication component, the delayed TXN record in association with the card TXN record;
determining, by the adjudication component, whether the card TXN record can be adjudicated using the stored delayed TXN record; and
designating, by the adjudication component, the card TXN record as adjudicated in response to adjudicating the card TXN record.

18. The non-transitory computer-readable device of claim 17, wherein the real-time card TXN is received from a point-of-sale terminal or from the card processor.

19. The non-transitory computer-readable device of claim 17, wherein the determining whether to associate the delayed TXN record with the card TXN record comprises:
matching a number of fields from the card TXN record with corresponding fields from the delayed TXN record, wherein a mismatch indicates that the delayed TXN record is not associated with the real-time card TXN.

20. The non-transitory computer-readable device of claim 17, wherein an adjudication keywords database includes a plurality of MCCs, each MCC being associated with a set of adjudication keywords, and wherein the determining whether the card TXN record can be adjudicated comprises:
matching keywords within the delayed TXN record against a set of adjudication keywords associated with an MCC corresponding to the transaction MCC.
